(19) United States
(12) Patent Application Publication
(10) Pub. No.: US 2017/0256202 A1
(43) Pub. Date: Sep. 7, 2017

(54) PIXEL CIRCUIT, DRIVING METHOD, ORGANIC ELECTROLUMINESCENT DISPLAY PANEL, AND DISPLAY DEVICE

(71) Applicant: Boe Technology Group Co., Ltd.,, Beijing, (CN)

(72) Inventor: Tuo Sun, Beijing (CN)

(21) Appl. No.: 15/320,407

(22) PCT Filed: Sep. 18, 2015
(86) PCT No.: PCT/CN2015/089967

§ 371 Date: Dec. 20, 2016

(30) Foreign Application Priority Data
May 28, 2015 (CN) 201510284618.X

(51) Int. Cl. G09G 3/3258; G09G 3/3291; G09G 3/3266

(52) U.S. Cl. CPC G09G 3/3258; G09G 3/3266; G09G 3/3291; G09G 2300/043; G09G 2320/0646; G09G 2300/0809; G09G 2320/0233

(57) ABSTRACT

A pixel circuit, a driving method, an organic electroluminescent display panel, and a display device are provided. The pixel circuit comprises a driving controller, a light emitter, a light emitting controller, an initialization controller, and a compensation controller. The pixel circuit can compensate the drift of the threshold voltage of the driving controller by using the preset threshold voltage which is written by the compensation controller and has a same threshold voltage as the driving controller. The driving current by which the driving controller drives the light emitter to emit light is only dependent on the voltage of the data signal and the voltage of the initialization signal, and independent on the threshold voltage of the driving controller, thus preventing the threshold voltage of the driving controller from affecting the light emitter.

### RELATED APPLICATIONS

The present application is the U.S. national phase entry of PCT/CN2015/089967, with an international filing date of Sep. 18, 2015, which claims the benefit of Chinese Patent Application No. 201510284618.X, filed on May 28, 2015, the entire disclosures of which are incorporated herein by reference.

### TECHNICAL FIELD

The present invention relates to the field of organic electroluminescence technique, and particularly to a pixel circuit, a driving method, an organic electroluminescent display panel, and a display device.

### BACKGROUND

Organic light emitting diodes (OLEDs) are among the research focuses in the display field. As compared with liquid crystal displays (LCDs), OLEDs have advantages of low energy consumption, low production cost, self-light emitting, wide viewing angles, and fast response. Currently, OLED display screens start to replace conventional LCD display screens in fields like mobile phones, PDAs, digital cameras. Design of a pixel circuit is one of the core techniques of the OLED display device, and has important research significance.

The brightness of LCDs is controlled by a stable voltage, while OLEDs are driven by a current, and a stable current is required to control light emitting. Due to process factors and device aging, driving transistors in the pixel circuit are non-uniform in the threshold voltage Vₜₕ. As a result, different currents flow through different pixels in the OLED, so that these pixels are not uniform in brightness, which affects the display effect of the whole image.

An existing 2T1C pixel circuit is shown in FIG. 1. The pixel circuit consists of one driving transistor T2, one switch transistor T1 and one storage capacitor Cs. When a scan line SL selects a row, the scan line SL inputs a low level signal, so that the P-type switch transistor T1 turns on, and a voltage of a data line DL is written into the storage capacitor Cs. After the row is scanned, the signal input by scan line SL changes to a high level, the P-type switch transistor T1 is cut off, and the voltage stored in the storage capacitor Cs controls the driving transistor T2 to produce a current for driving OLED pixels, which ensures the OLED pixels emit light continuously in a frame. The driving transistor T2 has a saturation current I_{OLED}=K(V_{SG}−Vₜₕ)², wherein V_{SG} is a voltage difference between a source and a gate of the driving transistor T2, K is a structural parameter, and Vₜₕ is a threshold voltage of the driving transistor T2. As mentioned above, the threshold voltage Vₜₕ of the driving transistor T2 may drift due to process factors and device aging. As a result, currents flowing through different pixels in the OLED vary with the variation of the threshold voltage Vₜₕ of the driving transistor, which leads to non-uniform image brightness.

### SUMMARY

Therefore, embodiments of the present invention provide a pixel circuit, comprising a driving controller, a light emitter, a light emitting controller, an initialization controller, and a compensation controller,

wherein the driving controller is configured to supply a driving current to the light emitter for driving the light emitter to emit light;

wherein in an initialization phase, the initialization controller is configured to, under the control of an initialization control signal, supply an initialization signal to the driving controller;

wherein in the compensation phase, the compensation controller is configured to, under the control of a compensation control signal and a data signal, write the data signal and a preset threshold voltage into the driving controller, wherein the preset threshold voltage has a same threshold voltage as the driving controller to compensate the drift of the threshold voltage of the driving controller; and

wherein in a light emitting phase, the light emitting controller is configured to, under the control of a light emitting control signal, supply a voltage of a first reference voltage line to an input terminal of the driving controller, store the data signal and the preset threshold voltage in another input terminal of the driving controller, and apply the driving current from the driving controller to the light emitter for driving the light emitter to emit light.

In a possible implementation, in an embodiment of the pixel circuit, the driving controller comprises a first input terminal which is connected with an output terminal of the initialization controller; a second input terminal which is connected with an output terminal of the compensation controller and a first output terminal of the light emitting controller; a third input terminal which is connected with a first input terminal of the light emitting controller and the first reference voltage line; and an output terminal which is connected with a second input terminal of the light emitting controller;

the initialization controller comprises a control terminal which is configured to receive the initialization control signal; an input terminal which is configured to receive the initialization signal; and an output terminal which is connected with the first input terminal of the driving controller;

the compensation controller comprises a first control terminal which is configured to receive the compensation control signal; a second control terminal which is configured to receive the data signal; an output terminal which is connected with the second input terminal of the driving controller and the first output terminal of the light emitting controller; and an input terminal which is connected with a second reference voltage line;

the light emitting controller comprises a first input terminal which is connected with the third input terminal of the driving controller and the first reference voltage line; a control terminal which is configured to receive the light emitting control signal; the second input terminal which is connected with an output terminal of the driving controller; the first output terminal which is connected with the second input terminal of the driving controller and the output terminal of the compensation controller; and a second output terminal which is connected with a terminal of the light emitter, and the other terminal of the light emitter is connected with a third reference voltage line.

In a possible implementation, in an embodiment of the pixel circuit, in the light emitting phase, the light emitting controller is configured to, under the control of the light emitting control signal, supply the voltage of the first reference voltage line to the second input terminal of the driving controller, and store the data signal and the preset threshold voltage in the first input terminal of the driving controller.

In a possible implementation, in an embodiment of the pixel circuit, the driving controller comprises a first driving transistor and capacitor,

wherein the first driving transistor comprises a gate, which is the first input terminal of the driving controller; a source, which is the third input terminal of the driving controller; and a drain, which is the output terminal of the driving controller, and the first driving transistor has a threshold voltage equal to that of the driving controller; and

wherein the capacitor comprises a first terminal which is connected with the gate of the first driving transistor, and a second terminal which is the second input terminal of the driving controller.

In a possible implementation, in an embodiment of the pixel circuit, the initialization controller comprises a first switch transistor,

wherein the first switch transistor comprises a gate, which is the control terminal of the initialization controller; a source, which is the input terminal of the initialization controller; and a drain, which is the output terminal of the initialization controller.

In a possible implementation, in an embodiment of the pixel circuit, the compensation controller comprises a second switch transistor and a second driving transistor,

wherein the second switch transistor comprises a gate, which is the first control terminal of the compensation controller; a drain, which is the input terminal of the compensation controller; and a source which is connected with the drain of the second driving transistor; and

wherein the second driving transistor comprises a gate, which is the second control terminal of the compensation controller; and a source, which is the output terminal of the compensation controller, wherein the second driving transistor has a threshold voltage equal to the preset threshold voltage.

For example, in an embodiment of the pixel circuit, the second driving transistor has a size and shape identical to that of the first driving transistor.

For example, in an embodiment of the pixel circuit, the second driving transistor is arranged close to the first driving transistor.

In a possible implementation, in an embodiment of the pixel circuit, the light emitting controller comprises a third switch transistor and a fourth switch transistor,

wherein the third switch transistor comprises a gate, which is the control terminal of the light emitting controller; a source, which is the first input terminal of the light emitting controller; and a drain, which is the first output terminal of the light emitting controller; and

wherein the fourth switch transistor comprises a gate, which is the control terminal of the light emitting controller; a source, which is the second input terminal of the light emitting controller; and a drain, which is the second output terminal of the light emitting controller.

For example, to simplify the fabricating process, in an embodiment of the pixel circuit, the first, second, third and fourth switch transistors are N-type transistors or P-type transistors.

Accordingly, an embodiment of the present invention further provides a method for driving the above pixel circuit, comprising:

in the initialization phase, by means of the initialization controller which is under the control of the initialization control signal, supplying the initialization signal to the first input terminal of the driving controller;

in the compensation phase, by means of the compensation controller which is under the control of the compensation control signal and the data signal, writing the data signal and the preset threshold voltage into the second input terminal of the driving controller; wherein the preset threshold voltage has a same threshold voltage as the driving controller;

in the light emitting phase, by means of the light emitting controller which is under the control of the light emitting control signal, supplying the voltage of the first reference voltage line to the second input terminal of the driving controller, storing the data signal and the preset threshold voltage in the first input terminal of the driving controller, and outputting the driving current from the driving controller to the light emitter for driving the light emitter to emit light.

Accordingly, an embodiment of the present invention further provides a organic electroluminescent display panel, which comprises any pixel circuit in the above embodiments.

Accordingly, an embodiment of the present invention further provides a display device, which comprises any organic electroluminescent display panel in the above embodiments of the present invention.

### BRIEF DESCRIPTION OF THE DRAWINGS

FIG. 1 is a structural view illustrating a pixel circuit of an existing 2T1C;

FIG. 2 is a structural view illustrating a pixel circuit in an embodiment of the present invention;

FIG. 3a is a structural view illustrating a specific pixel circuit in an embodiment of the present invention;

FIG. 3b is a structural view illustrating another specific pixel circuit in an embodiment of the present invention;

FIG. 4a is a circuit timing diagram for the pixel circuit of FIG. 3a;

FIG. 4b is a circuit timing diagram for the pixel circuit of FIG. 3b; and

FIG. 5 is a flow chart illustrating a method for driving a pixel circuit in an embodiment of the present invention.

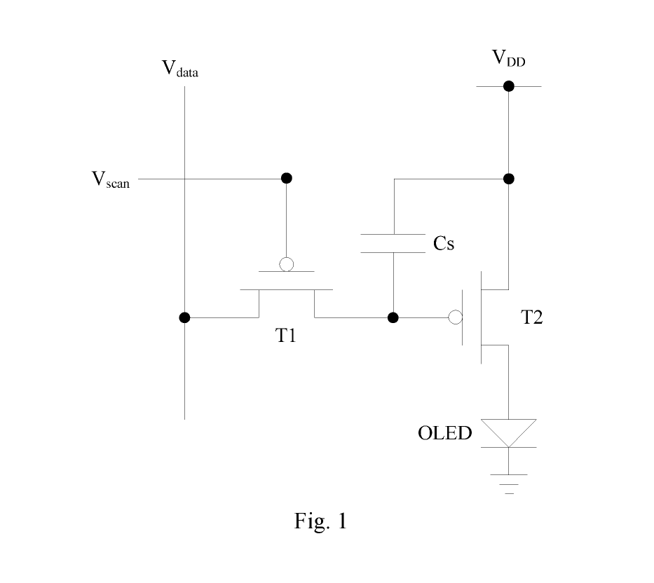

### DETAILED DESCRIPTION OF EMBODIMENTS

The pixel circuit, the driving method, the organic electroluminescent display panel, and the display device will be further described in the following text with reference to figures and embodiments.

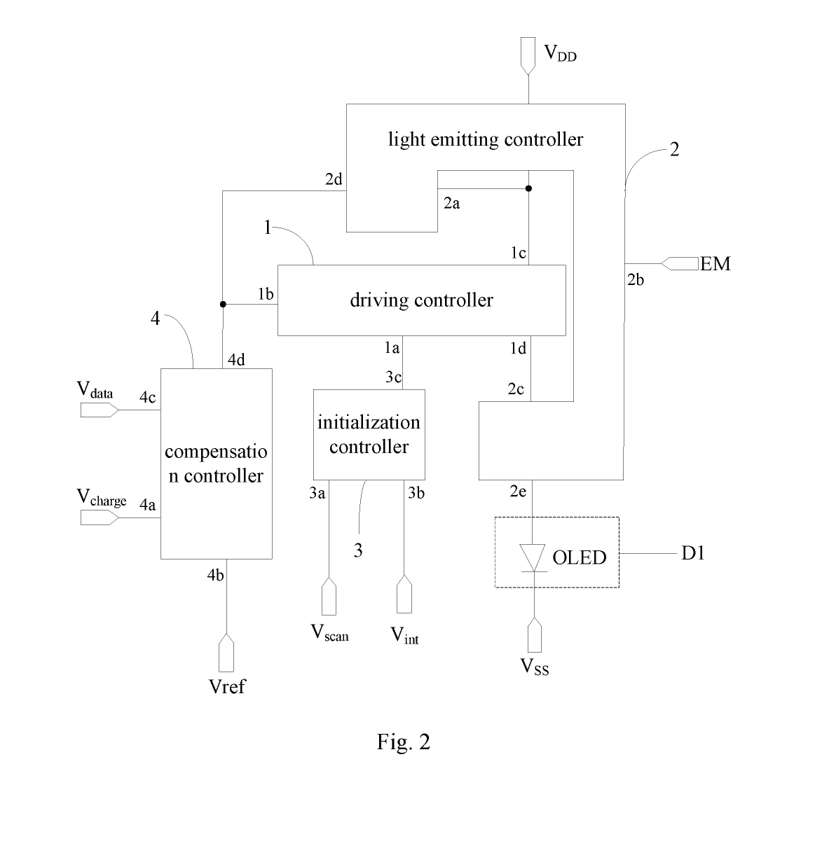

In an embodiment of the present invention, as shown in FIG. 2, a pixel circuit comprises a driving controller 1, a light emitter D1, a light emitting controller 2, an initialization controller 3, and a compensation controller 4.

The driving controller 1 comprises a first input terminal 1a, which is connected with an output terminal 3c of the initialization controller 3; a second input terminal 1b, which is connected with an output terminal 4d of the compensation controller 4 and a first output terminal 2d of the light emitting controller 2; a third input terminal 1c, which is connected with a first input terminal 2a of the light emitting controller 2 and a first reference voltage line VDD; and an output terminal 1d, which is connected with a second input terminal 2c of the light emitting controller 2. The driving controller 1 is configured to supply a driving current to the light emitter D1 for driving the light emitter D1 to emit light.

The initialization controller 3 comprises a control terminal 3a for receiving an initialization control signal V_{scan}; an input terminal 3b for receiving an initialization signal Vᵢₙₜ; and the output terminal 3c which is connected with the first input terminal 1a of the driving controller 1. The initialization controller 3 is configured to, under the control of the initialization control signal V_{scan}, supply the initialization signal Vᵢₙₜ to the first input terminal 1a of the driving controller 1.

The compensation controller 4 comprises a first control terminal 4a for receiving a compensation control signal V_{charge}; a second control terminal 4c for receiving a data signal V_{data}; the output terminal 4d which is connected with the second input terminal 1b of the driving controller 1; and an input terminal 4b which is connected with a second reference voltage line Vref. The compensation controller 4 is configured to, under the control of the compensation control signal V_{charge} and the data signal V_{data}, write the data signal Vdata and a preset threshold voltage into the second input terminal 1b of the driving controller 1. The preset threshold voltage and the driving controller 1 have a same threshold voltage.

The light emitting controller 2 comprises the first input terminal 2a which is connected with the third input terminal 1c of the driving controller 1 and the first reference voltage line VDD; a control terminal 2b for receiving a light emitting control signal EM; the second input terminal 2c which is connected with the output terminal 1d of the driving controller 1; the first output terminal 2d which is connected with the second input terminal 1b of the driving controller 1 and the output terminal 4d of the compensation controller 4; and a second output terminal 2e which is connected with a terminal of the light emitter D1. The other terminal of the light emitter D1 is connected with a third reference voltage line VSS. The light emitting controller 2 is configured to, under the control of the light emitting control signal EM, supply a voltage V_{DD} of the first reference voltage line VDD to the second input terminal 1b of the driving controller 1, store the data signal V_{data} and the preset threshold voltage in the first input terminal 1a of the driving controller 1, and output a driving current from the driving controller 1 to the light emitter D1 for driving the light emitter D1 to emit light.

In an embodiment of the present invention, the pixel circuit comprises the driving controller, the light emitter, the light emitting controller, the initialization controller, and the compensation controller. These modules cooperate with one another, and by using the preset threshold voltage which is written by the compensation controller and has a same threshold voltage as the driving controller, the pixel circuit can compensate the drift of the threshold voltage of the driving controller. Therefore, during emitting light to display, the driving current by which the driving controller drives the light emitter to emit light is only dependent on the voltage of the data signal and the voltage of the initialization signal, and independent on the threshold voltage of the driving controller, thus preventing the threshold voltage of the driving controller from affecting the light emitter. In other words, when different pixel units are supplied with an identical data signal, images of identical brightness can be obtained, which improves uniformity of image brightness in the display region of the display device.

The specific embodiments of the present invention shall be further described hereinafter. The following embodiments are only used for explaining more clearly the technical solution of the present invention rather than limiting the protection scope of the present invention.

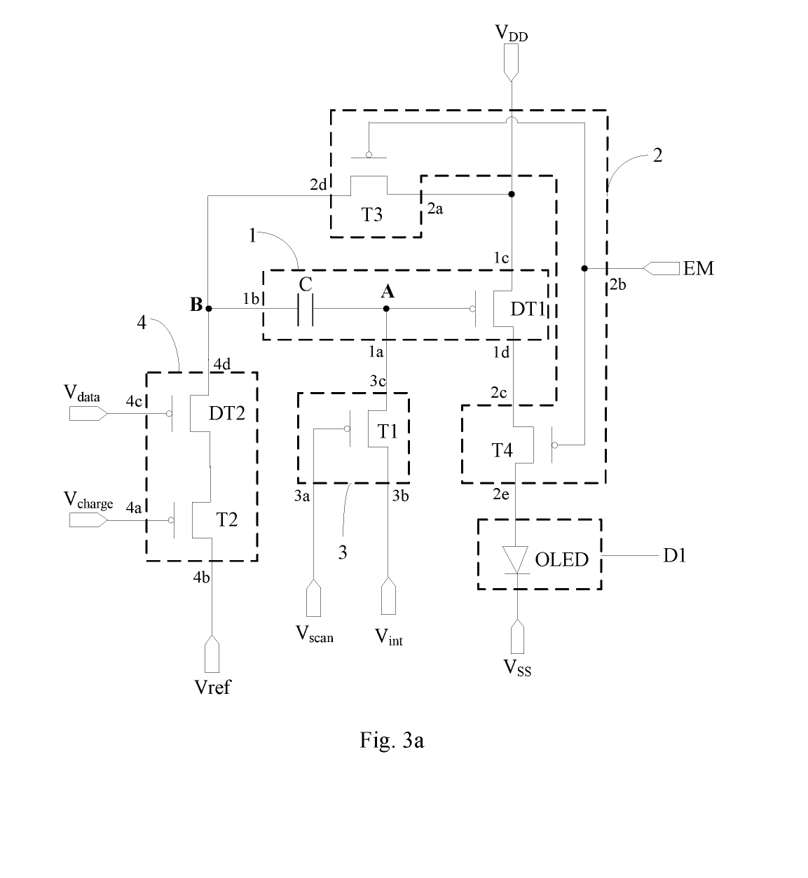

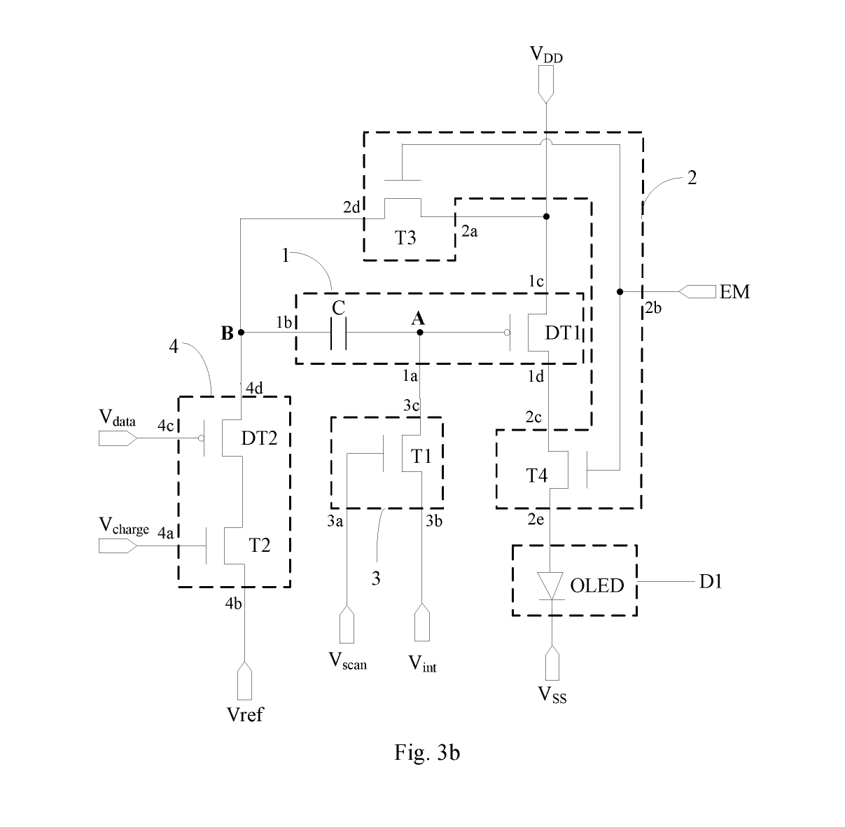

For example, in an embodiment of the pixel circuit, as shown in FIG. 3a and FIG. 3b, the driving controller 1 specifically comprises a first driving transistor DT1 and a capacitor C.

The first driving transistor DT1 comprises a gate, which is the first input terminal 1a of the driving controller 1; a source, which is the third input terminal 1c of the driving controller 1; and a drain, which is the output terminal 1d of the driving controller 1. The first driving transistor DT1 has a threshold voltage Vₜₕ₁ equal to the threshold voltage of the driving controller 1.

The capacitor C comprises a first terminal which is connected with the gate of the first driving transistor DT1, and a second terminal which is the second input terminal 1b of the driving controller 1.

During implementation, in an embodiment of the pixel circuit, the first driving transistor DT1 is generally a P-type transistor. Since the P-type transistor has a threshold voltage of a negative value, in order to ensure normal operation of the first driving transistor DT1, the voltage V_{DD} of the first reference voltage line VDD is generally a positive voltage, and the voltage V_{SS} of the third reference voltage line VSS is generally a ground potential or a negative value.

Furthermore, during implementation, in an embodiment of the pixel circuit, the light emitter D1 is generally an OLED. As shown in FIGS. 3a and 3b, an anode of the OLED is connected with the second output terminal 2e of the light emitting controller 2, a cathode of the OLED is connected with the third reference voltage line VSS, and the OLED emits light for displaying under a saturation current of the first driving transistor DT1.

For example, in an embodiment of the pixel circuit, as shown in FIG. 3a and FIG. 3b, the initialization controller 3 can specifically comprise a first switch transistor T1.

The first switch transistor T1 comprises a gate, which is the control terminal 3a of the initialization controller 3; a source, which is the input terminal 3b of the initialization controller 3; and a drain, which is the output terminal 3c of the initialization controller 3.

Furthermore, during implementation, as shown in FIG. 3a, the first switch transistor T1 can be a P-type transistor. In this case, when the initialization control signal V_{scan} is a low level, the first switch transistor T1 is in an on-state, and when the initialization control signal V_{scan} is a high level, the first switch transistor T1 is in an off-state. Alternatively, as shown in FIG. 3b, the first switch transistor T1 can also be a N type transistor. In this case, when the initialization control signal V_{scan} is a high level, the first switch transistor T1 is in the on-state, and when the initialization control signal V_{scan} is a low level, the first switch transistor T1 is in the off-state. The present invention is not limited in term of the type of the first switch transistor T1.

In particular, in an embodiment of the pixel circuit, when the first switch transistor is in the on-state under the control of the initialization control signal, the initialization signal is transferred to the first input terminal of the driving controller via the first switch transistor in the on-state, so that a function of initializing the first input terminal of the driving controller is realized.

In the foregoing, the structure of the initialization controller in the pixel circuit is described in an exemplary manner. During implementation, the initialization controller is not limited to the structure as described above, but can have other structures which are known for a person with ordinary skill in the art.

For example, in an embodiment of the pixel circuit, as shown in FIG. 3a and FIG. 3b, the compensation controller 4 can specifically comprise a second switch transistor T2 and a second driving transistor DT2.

The second switch transistor T2 comprises a gate, which is the first control terminal 4a of the compensation controller 4; a drain, which is the input terminal 4b of the compensation controller 4; and a source which is connected with the drain of the second driving transistor DT2.

The second driving transistor DT2 comprises a gate, which is the second control terminal 4c of the compensation controller 4; and a source, which is the output terminal 4d of the compensation controller 4. The second driving transistor DT2 has a threshold voltage V which is a preset threshold voltage. Namely, the second driving transistor DT2 has the threshold voltage V which is equal to the threshold voltage Vₜₕ₁ of the first driving transistor DT1.

Furthermore, during implementation, since the first driving transistor DT1 is generally a P-type transistor, and the threshold voltage Vₜₕ₂ of the second driving transistor DT2 equals to the threshold voltage Vₜₕ₁ of the first driving transistor DT1, the second driving transistor DT2 and the first driving transistor DT1 are of a same polarity. Therefore, the second driving transistor generally is also a P-type transistor.

For example, during implementation, the second driving transistor DT2 has a same size and shape as the size and shape of the first driving transistor DT1, and the second driving transistor DT2 is arranged close to the first driving transistor DT1, so that the threshold voltage Vₜₕ₂ of the second driving transistor DT2 equals to the threshold voltage Vₜₕ₁ of the first driving transistor DT1. In this way, the threshold voltage Vₜₕ₂ of the second driving transistor DT2 is made equal to the threshold voltage Vₜₕ₁ of the first driving transistor DT1 by decreasing process difference.

Furthermore, during implementation, as shown in FIG. 3a, the second switch transistor T2 can be a P-type transistor. In this case, when the compensation control signal V_{charge} is a low level, the second switch transistor T2 is in the on-state, and when the compensation control signal V_{charge} is a high level, the second switch transistor T2 is in the off-state. Alternatively, as shown in FIG. 3b, the second switch transistor T2 can also be a N type transistor. In this case, when the compensation control signal V_{charge} is a high level, the second switch transistor T2 is in the on-state, and when the compensation control signal V_{charge} is a low level, the second switch transistor T2 is in the off-state. The present invention is not limited in term of the type of the second switch transistor T2.

In particular, in an embodiment of the pixel circuit, when the second switch transistor T2 is in the on-state under the control of the compensation control signal V_{discharge}, and the second driving transistor DT2 is in the on-state under the control of the data signal V_{data}, the driving controller 1 starts to discharge, until the source voltage of the second driving transistor DT2 is V_{data}−Vₜₕ₂. The second driving transistor DT2 is in a subthreshold state, and the source voltage of the second driving transistor DT2 is kept at V_{data}−Vₜₕ₂, so that a function of writing the voltage of the data signal V_{data} and Vₜₕ₂ into the second input terminal 1b of the driving controller 1 is realized.

In the foregoing, the structure of the compensation controller in the pixel circuit is described in an exemplary manner. During implementation, the compensation controller is not limited to the structure as described above, but can have other structures which are known for the person with ordinary skill in the art.

For example, in an embodiment of the pixel circuit, as shown in FIG. 3a and FIG. 3b, the light emitting controller 2 can specifically comprise a third switch transistor T3 and a fourth switch transistor T4.

The third switch transistor T3 comprises a gate, which is the control terminal 2b of the light emitting controller 2; a source, which is the first input terminal 2a of the light emitting controller 2; and a drain, which is the first output terminal 2d of the light emitting controller 2.

The fourth switch transistor T4 comprises a gate, which is the control terminal 2b of the light emitting controller 2; a source, which is the second input terminal 2c of the light emitting controller 2; and a drain, which is the second output terminal 2e of the light emitting controller.

Furthermore, during implementation, as shown in FIG. 3a, the third switch transistor T3 and the fourth switch transistor T4 can be P-type transistors. In this case, when the light emitting control signal EM is a low level, the third switch transistor T3 and the fourth switch transistor T4 are in the on-state, and when the light emitting control signal EM is a high level, the third switch transistor T3 and the fourth switch transistor T4 are in the off-state. Alternatively, as shown in FIG. 3b, the third switch transistor T3 and the fourth switch transistor T4 can also be N type transistors. In this case, when the light emitting control signal EM is a high level, the third switch transistor T3 and the fourth switch transistor T4 are in the on-state, and when the light emitting control signal EM is a low level, the third switch transistor T3 and the fourth switch transistor T4 are in the off-state. The present invention is not limited in term of the type of the third switch transistor T3 and the fourth switch transistor T4.

In particular, in an embodiment of the pixel circuit, when the third switch transistor T3 and the fourth switch transistor T4 are in the on-state under the control of the light emitting control signal, the voltage V_{DD} of the first reference voltage line VDD is transferred to the second input terminal 1b of the driving controller via the third switch transistor T3 in the on-state. The driving controller 1 stores the data signal V_{data} and the preset threshold voltage Vₜₕ₂ in the first input terminal 1a. The fourth switch transistor T4 in the on-state outputs the driving current from the driving controller 1 to the light emitter D1, so as to drive the light emitter D1 to emit light.

In the foregoing, the structure of the light emitting controller in the pixel circuit is described in an exemplary manner. During implementation, the light emitting controller is not limited to the structure as described above, but can have other structures which are known for the person with ordinary skill in the art.

It is noted that the driving transistor and the switch transistor in the embodiments can be thin film transistors (TFTs), or metal-oxide semiconductor field effect transistors (MOS-FETs).

For example, in order to simplify the fabricating process, in an embodiment of the pixel circuit, all switch transistors are P-type transistors, or all switch transistors are N-type transistors.

For example, in an embodiment of the pixel circuit, all driving transistors and switch transistors can be P-type transistors, thus simplifying the process for fabricating the pixel circuit.

The operation of a pixel circuit in an embodiment of the present invention will be described hereinafter by taking the pixel circuit shown in FIG. 3a and FIG. 3b as an example. Only for purpose of ease of description, it is defined that the first input terminal 1a of the driving controller 1 is a first node A, and the second input terminal 1b of the driving controller 1 is a second node B. In the following description, 1 indicates a high level signal, and 0 indicates a low level signal.

### EXAMPLE 1

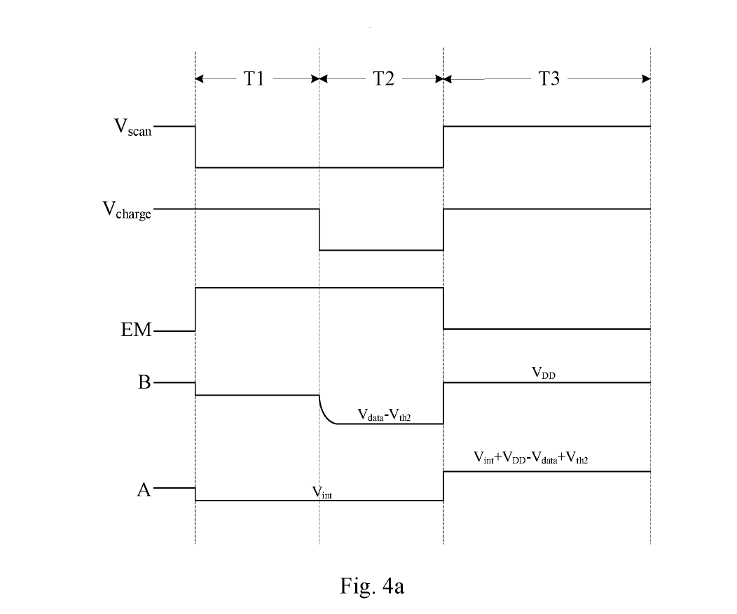

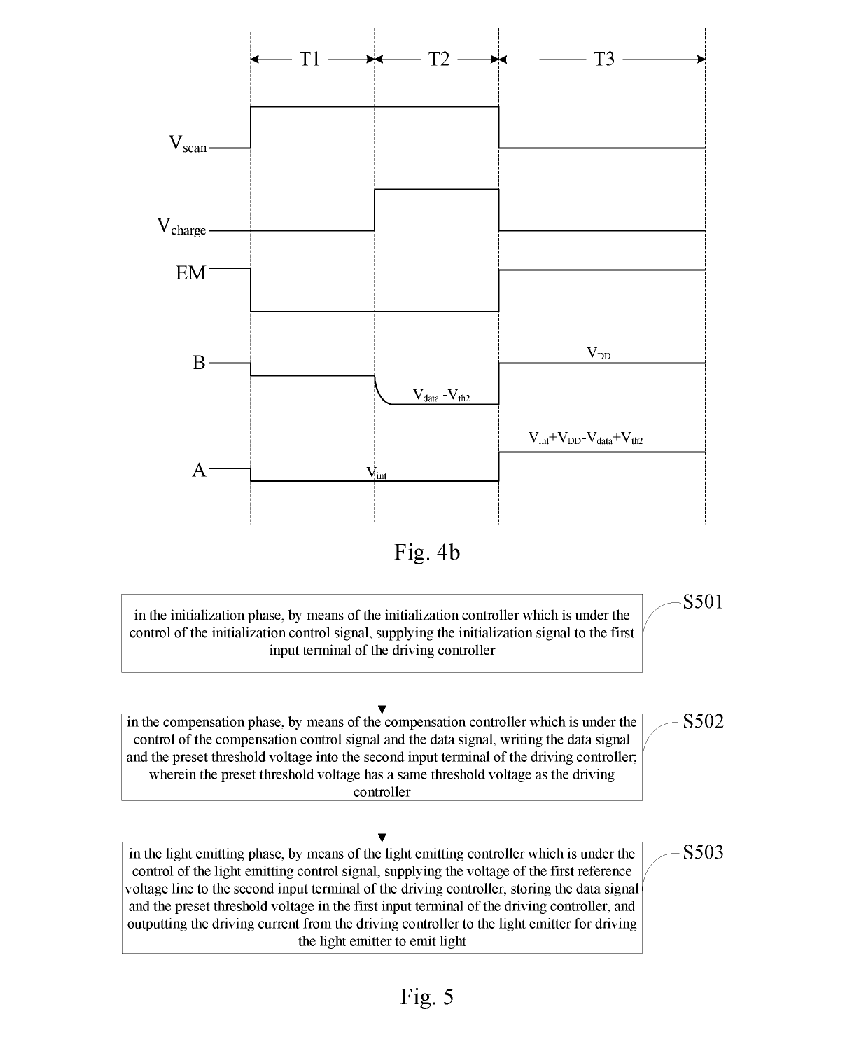

The operation of the pixel circuit is described by taking the pixel circuit shown in FIG. 3a as an example. In the pixel circuit shown in FIG. 3a, the first driving transistor DT1 and the second driving transistor DT2 are P-type transistors, and all switch transistors are P-type transistors. Each of the P-type transistors is cut off under the high level, and turns on under the low level. The corresponding input timing diagram is shown in FIG. 4a. In particular, three phases T1, T2, and T3 in the input timing diagram shown in FIG. 4a are selected.

In the phase T1, V_{scan}=0, V_{charge}=1, and EM=1. Accordingly, the first switch transistor T1 is in the on-state, while the second switch transistor T2, the third switch transistor T3 and the fourth switch transistor T4 are in the off-state. The initialization signal Vᵢₙₜ is supplied to the first node A via the first switch transistor T1 in the on-state. Therefore, in this phase, a voltage of the first node A is Vᵢₙₜ, and a voltage of the second node B decreases as the voltage of the first node A decreases.

In the phase T2, V_{scan}=0, V_{charge}=0, and EM=1. Accordingly, the first switch transistor T1 and the second switch transistor T2 are in the on-state, while the third switch transistor T3 and the fourth switch transistor T4 are in the off-state. The initialization signal Vᵢₙₜ is supplied to the first node A via the first switch transistor T1 in the on-state. Since the second switch transistor T2 turns on, the capacitor C starts to dischargevia the second driving transistor DT2. Until the source voltage of the second driving transistor DT2 is V_{data}−Vₜₕ₂, i.e., the second driving transistor DT2 is in the subthreshold state, the capacitor C stops discharging. In this phase, the voltage of the first node A is still Vᵢₙₜ, and the voltage of the second node B gradually decreases to V_{data}−Vₜₕ₂.

In the phase T3, V_{scan}=1, V_{charge}=1, and EM=0. The first switch transistor T1 and the second switch transistor T2 are in the off-state, while the third switch transistor T3 and the fourth switch transistor T4 are in the on-state. In this phase, since the third switch transistor T3 turns on, the voltage of the second node B changes from V_{data}−Vₜₕ₂ in the previous phase to the voltage V_{DD} of the first reference voltage line VDD. According to the principle of charge conservation in the capacitor, the voltage of the first node A changes from Vᵢₙₜ in the previous phase to Vᵢₙₜ+V_{DD}−(V_{data}−Vₜₕ₂). Therefore, in this phase, the gate of the first driving transistor DT1 has a voltage which is kept at Vᵢₙₜ+V_{DD}−(V_{data}−Vₜₕ₂), the source voltage of the first driving transistor DT1 is V_{DD}, and the first driving transistor DT1 operates in the saturation state. According to the saturation state current characteristics, the operating current I_{OLED} which runs through the first driving transistor DT1 and drives the OLED to emit light satisfies the following formula: I_{OLED}=K(V_{gs}−Vₜₕ₁)²=K[Vᵢₙₜ+V_{DD}−(V_{data}−Vₜₕ₂)−V_{DD}−Vₜₕ₁]²=K(Vᵢₙₜ−V_{data}+Vₜₕ₂−Vₜₕ₁)², wherein K is a structural parameter. K has a relatively stable value in identical structures, and thus can be deemed as a constant. Since the threshold voltage V of the second driving transistor DT2 equals to the threshold voltage Vₜₕ₁ of the first driving transistor DT1, the operating current I_{OLED}=K(Vᵢₙₜ−V_{data})². As can be seen, the operating current I_{OLED} of the OLED is no longer affected by the threshold voltage Vₜₕ₁ of the first driving transistor DT1, and is independent from the voltage V_{DD} of the first reference voltage line VDD and only dependent on the voltage of the data signal V_{data} and the initialization signal Vᵢₙₜ. Therefore, the effect of the drift and IR drop of the threshold voltage Vₜₕ₁ of the first driving transistor DT1 (due to process factors and long-time operation) on the operating current I_{OLED} of the light emitter D1 is completely eliminated, which decreases non-uniformity of panel display.

### EXAMPLE 2

The operation of the pixel circuit is described by taking the pixel circuit shown in FIG. 3b as an example. In the pixel circuit shown in FIG. 3b, the first driving transistor DT1 and the second driving transistor DT2 are P-type transistors, and all switch transistors are N-type transistors. Each of the N-type transistors turns on under the high level, and is cut off under the low level. The corresponding input timing diagram is shown in FIG. 4b. In particular, three phases T1, T2, and T3 in the input timing diagram shown in FIG. 4b are selected.

In the phase T1, V_{scan}=1, V_{charge}=0, and EM=0. Accordingly, the first switch transistor T1 is in the on-state, while the second switch transistor T2, the third switch transistor T3 and the fourth switch transistor T4 are in the off-state. The initialization signal Vᵢₙₜ is supplied to the first node A via the first switch transistor T1 in the on-state. Therefore, in this phase, the voltage of the first node A is Vᵢₙₜ, and the voltage of the second node B decreases as the voltage of the first node A decreases.

In the phase T2, V_{scan}=1, V_{charge}=1, and EM=0. Accordingly, the first switch transistor T1 and the second switch transistor T2 are in the on-state, while the third switch transistor T3 and the fourth switch transistor T4 are in the off-state. The initialization signal Vᵢₙₜ is supplied to the first node A via the first switch transistor T1 in the on-state. Since the second switch transistor T2 turns on, the capacitor C starts to discharge via the second driving transistor DT2. Until the source voltage of the second driving transistor DT2 is V_{data}−Vₜₕ₂, i.e., the second driving transistor DT2 is in the subthreshold state, the capacitor C stops discharging. In this phase, the voltage of the first node A is still Vᵢₙₜ, and the voltage of the second node B gradually decreases to V_{data}−Vₜₕ₂.

In the phase T3, V_{scan}=0, V_{charge}=0, and EM=1. The first switch transistor T1 and the second switch transistor T2 are in the off-state, while the third switch transistor T3 and the fourth switch transistor T4 are in the on-state. In this phase, since the third switch transistor T3 turns on, the voltage of the second node B changes from V_{data}−Vₜₕ₂ in the previous phase to the voltage V_{DD} of the first reference voltage line VDD. According to the principle of charge conservation in the capacitor, the voltage of the first node A changes from Vᵢₙₜ in the previous phase to Vᵢₙₜ+V_{DD}−(V_{data}−Vₜₕ₂). Therefore, in this phase, the gate of the first driving transistor DT1 has a voltage which is kept at Vᵢₙₜ+V_{DD}−(V_{data}−Vₜₕ₂), the source voltage of the first driving transistor DT1 is V_{DD}, and the first driving transistor DT1 operates in the saturation state. According to the saturation state current characteristics, the operating current I_{OLED} which runs through the first driving transistor DT1 and drives the OLED to emit light satisfies the following formula: I_{OLED}=K(V_{gs}−Vₜₕ₁)²=K[Vᵢₙₜ+V_{DD}−(V_{data}−Vₜₕ₂)−V_{DD}−Vₜₕ₁]²=K(Vᵢₙₜ−V_{data}+Vₜₕ₂−Vₜₕ₁)², wherein K is the structural parameter. K has a relatively stable value in identical structures, and thus can be deemed as a constant. Since the threshold voltage Vₜₕ₂ of the second driving transistor DT2 equals to the threshold voltage Vₜₕ₁ of the first driving transistor DT1, the operating current I_{OLED}=K(Vᵢₙₜ−V_{data})². As can be seen, the operating current I_{OLED} of the OLED is no longer affected by the threshold voltage Vₜₕ₁ of the first driving transistor DT1, and is independent from the voltage V_{DD} of the first reference voltage line VDD and only dependent on the voltage of the data signal V_{data} and the initialization signal Vᵢₙₜ. Therefore, the effect of the drift and IR drop of the threshold voltage Vₜₕ₁ of the first driving transistor DT1 (due to process factors and long-time operation) on the operating current I_{OLED} of the light emitter D1 is completely eliminated, which decreases non-uniformity of panel display.

On basis of the same inventive concept, an embodiment of the present invention further provides a method for driving the above pixel circuit. As shown in FIG. 5, the driving method comprises:

S501, in the initialization phase, by means of the initialization controller which is under the control of the initialization control signal, supplying the initialization signal to the first input terminal of the driving controller;

S502, in the compensation phase, by means of the compensation controller which is under the control of the compensation control signal and the data signal, writing the data signal and the preset threshold voltage into the second input terminal of the driving controller; wherein the preset threshold voltage has a same threshold voltage as the driving controller; and

S503, in the light emitting phase, by means of the light emitting controller which is under the control of the light emitting control signal, supplying the voltage of the first reference voltage line to the second input terminal of the driving controller, storing the data signal and the preset threshold voltage in the first input terminal of the driving controller, and outputting the driving current from the driving controller to the light emitter for driving the light emitter to emit light.

On basis of the same inventive concept, an embodiment of the present invention further provides an OLED display panel, which comprises any pixel circuit in the above embodiments. The OLED display panel solves the problem with a principle similar with the foregoing pixel circuit. Therefore, as for implementations of the pixel circuit in the OLED display panel, reference can be made to the above embodiments of the pixel circuit, which are not repeated for simplicity.

On basis of the same inventive concept, an embodiment of the present invention further provides a display device, which comprises the above OLED display panel. The display device can be a monitor, a mobile phone, a TV set, a notebook computer, an electric paper, a digital photo frame, a navigator, an all-in-one machine, or the like. The display device further comprises other essential parts, but these parts are known for the person with ordinary skill in the art and thus are not repeated herein for simplicity. These parts shall not be read as limitations to the present invention.

In the pixel circuit, the driving method, the organic electroluminescent display panel, and the display device of the above embodiments, the pixel circuit comprises the driving controller, the light emitter, the light emitting controller, the initialization controller, and the compensation controller. These modules cooperate with one another, and by using the preset threshold voltage which is written by the compensation controller and has a same threshold voltage as the driving controller, the pixel circuit can compensate the drift of the threshold voltage of the driving controller. Therefore, during emitting light to display, the driving current by which the driving controller drives the light emitter to emit light is only dependent on the voltage of the data signal and the voltage of the initialization signal, and independent on the threshold voltage of the driving controller, thus preventing the threshold voltage of the driving controller from affecting the light emitter. Namely, when different pixel units are supplied with an identical data signal, images of identical brightness can be obtained, which improves uniformity of image brightness in the display region of the display device.

Apparently, the person with ordinary skill in the art can make various modifications and variations to the present invention without departing from the spirit and the scope of the present invention. In this way, provided that these modifications and variations of the present invention belong to the scopes of the claims of the present invention and the equivalent technologies thereof, the present invention also intends to encompass these modifications and variations.

1. A pixel circuit, comprising a driving controller, a light emitter, a light emitting controller, an initialization controller, and a compensation controller,
wherein the driving controller is configured to supply a driving current to the light emitter for driving the light emitter to emit light;
wherein in an initialization phase, the initialization controller is configured to, under the control of an initialization control signal, supply an initialization signal to the driving controller;
wherein in the compensation phase, the compensation controller is configured to, under the control of a compensation control signal and a data signal, write the data signal and a preset threshold voltage into the driving controller, wherein the preset threshold voltage has a same threshold voltage as the driving controller to compensate the drift of the threshold voltage of the driving controller; and
wherein in a light emitting phase, the light emitting controller is configured to, under the control of a light emitting control signal, supply a voltage of a first reference voltage line to an input terminal of the driving controller, store the data signal and the preset threshold voltage in another input terminal of the driving controller, and apply the driving current from the driving controller to the light emitter for driving the light emitter to emit light.

2. The pixel circuit of claim 1, wherein,
the driving controller comprises a first input terminal which is connected with an output terminal of the initialization controller; a second input terminal which is connected with an output terminal of the compensation controller and a first output terminal of the light emitting controller; a third input terminal which is connected with a first input terminal of the light emitting controller and the first reference voltage line; and an output terminal which is connected with a second input terminal of the light emitting controller;
the initialization controller comprises a control terminal which is configured to receive the initialization control signal; an input terminal which is configured to receive the initialization signal; and an output terminal which is connected with the first input terminal of the driving controller;
the compensation controller comprises a first control terminal which is configured to receive the compensation control signal; a second control terminal which is configured to receive the data signal; an output terminal which is connected with the second input terminal of the driving controller and the first output terminal of the light emitting controller; and an input terminal which is connected with a second reference voltage line;
the light emitting controller comprises a first input terminal which is connected with the third input terminal of the driving controller and the first reference voltage line; a control terminal which is configured to receive the light emitting control signal; the second input terminal which is connected with an output terminal of the driving controller; the first output terminal which is connected with the second input terminal of the driving controller and the output terminal of the compensation controller; and a second output terminal which is connected with a terminal of the light emitter, and the other terminal of the light emitter is connected with a third reference voltage line.

3. The pixel circuit of claim 2, wherein in the light emitting phase, the light emitting controller is configured to, under the control of the light emitting control signal, supply the voltage of the first reference voltage line to the second input terminal of the driving controller, and store the data signal and the preset threshold voltage in the first input terminal of the driving controller.

4. The pixel circuit of claim 2, wherein the driving controller comprises a first driving transistor and capacitor,
wherein the first driving transistor comprises a gate, which is the first input terminal of the driving controller; a source, which is the third input terminal of the driving controller; and a drain, which is the output terminal of the driving controller, and the first driving transistor has a threshold voltage equal to that of the driving controller; and
wherein the capacitor comprises a first terminal which is connected with the gate of the first driving transistor, and a second terminal which is the second input terminal of the driving controller.

5. The pixel circuit of claim 2, wherein the initialization controller comprises a first switch transistor,
wherein the first switch transistor comprises a gate, which is the control terminal of the initialization controller; a source, which is the input terminal of the initialization controller; and a drain, which is the output terminal of the initialization controller.

6. The pixel circuit of claim 5, wherein the compensation controller comprises a second switch transistor and a second driving transistor,
wherein the second switch transistor comprises a gate, which is the first control terminal of the compensation controller; a drain, which is the input terminal of the compensation controller; and a source which is connected with the drain of the second driving transistor; and
wherein the second driving transistor comprises a gate, which is the second control terminal of the compensation controller; and a source, which is the output terminal of the compensation controller, wherein the second driving transistor has a threshold voltage equal to the preset threshold voltage.

7. The pixel circuit of claim 6, wherein the second driving transistor has a size and shape identical to that of the first driving transistor.

8. The pixel circuit of claim 7, wherein the second driving transistor is arranged close to the first driving transistor.

9. The pixel circuit of claim 6, wherein the light emitting controller comprises a third switch transistor and a fourth switch transistor,
wherein the third switch transistor comprises a gate, which is the control terminal of the light emitting controller; a source, which is the first input terminal of the light emitting controller; and a drain, which is the first output terminal of the light emitting controller; and
wherein the fourth switch transistor comprises a gate, which is the control terminal of the light emitting controller; a source, which is the second input terminal of the light emitting controller; and a drain, which is the second output terminal of the light emitting controller.

10. The pixel circuit of claim 9, wherein the first switch transistor, the second switch transistor, the third switch transistor, and the fourth switch transistor are N-type transistors.

11. A method for driving a pixel circuit that comprises a driving controller, a light emitter, a light emitting controller, an initialization controller, and a compensation controller, wherein the driving controller is configured to supply a driving current to the light emitter for driving the light emitter to emit light; wherein in an initialization phase, the initialization controller is configured to, under the control of an initialization control signal, supply an initialization signal to the driving controller; wherein in the compensation phase, the compensation controller is configured to, under the control of a compensation control signal and a data signal, write the data signal and a preset threshold voltage into the driving controller, wherein the preset threshold voltage has a same threshold voltage as the driving controller to compensate the drift of the threshold voltage of the driving controller, and wherein in a light emitting phase, the light emitting controller is configured to, under the control of a light emitting control signal, supply a voltage of a first reference voltage line to an input terminal of the driving controller, store the data signal and the preset threshold voltage in another input terminal of the driving controller, and apply the driving current from the driving controller to the light emitter for driving the light emitter to emit light, the method comprising:
in the initialization phase, by means of the initialization controller which is under the control of the initialization control signal, supplying the initialization signal to the first input terminal of the driving controller;
in the compensation phase, by means of the compensation controller which is under the control of the compensation control signal and the data signal, writing the data signal and the preset threshold voltage into the second input terminal of the driving controller; wherein the preset threshold voltage has a same threshold voltage as the driving controller;
in the light emitting phase, by means of the light emitting controller which is under the control of the light emitting control signal, supplying the voltage of the first reference voltage line to the second input terminal of the driving controller, storing the data signal and the preset threshold voltage in the first input terminal of the driving controller, and outputting the driving current from the driving controller to the light emitter for driving the light emitter to emit light.

12. An organic electroluminescent display panel, comprising a pixel circuit, wherein the pixel circuit comprises a driving controller, a light emitter, a light emitting controller, an initialization controller, and a compensation controller,
wherein the driving controller is configured to supply a driving current to the light emitter for driving the light emitter to emit light;
wherein in an initialization phase, the initialization controller is configured to, under the control of an initialization control signal, supply an initialization signal to the driving controller;
wherein in the compensation phase, the compensation controller is configured to, under the control of a compensation control signal and a data signal, write the data signal and a preset threshold voltage into the driving controller, wherein the preset threshold voltage has a same threshold voltage as the driving controller to compensate the drift of the threshold voltage of the driving controller; and
wherein in a light emitting phase, the light emitting controller is configured to, under the control of a light emitting control signal, supply a voltage of a first reference voltage line to an input terminal of the driving controller, store the data signal and the preset threshold voltage in another input terminal of the driving controller, and apply the driving current from the driving controller to the light emitter for driving the light emitter to emit light.

13. A display device, comprising the organic electroluminescent display panel of claim 12.

14. The pixel circuit of claim 9, wherein the first switch transistor, the second switch transistor, the third switch transistor, and the fourth switch transistor are P-type transistors.

15. The organic electroluminescent display panel of claim 12, wherein,
the driving controller comprises a first input terminal which is connected with an output terminal of the initialization controller; a second input terminal which is connected with an output terminal of the compensation controller and a first output terminal of the light emitting controller; a third input terminal which is connected with a first input terminal of the light emitting controller and the first reference voltage line; and an output terminal which is connected with a second input terminal of the light emitting controller;
the initialization controller comprises a control terminal which is configured to receive the initialization control signal; an input terminal which is configured to receive the initialization signal; and an output terminal which is connected with the first input terminal of the driving controller;
the compensation controller comprises a first control terminal which is configured to receive the compensation control signal; a second control terminal which is configured to receive the data signal; an output terminal which is connected with the second input terminal of the driving controller and the first output terminal of the light emitting controller; and an input terminal which is connected with a second reference voltage line;
the light emitting controller comprises a first input terminal which is connected with the third input terminal of the driving controller and the first reference voltage line; a control terminal which is configured to receive the light emitting control signal; the second input terminal which is connected with an output terminal of the driving controller; the first output terminal which is connected with the second input terminal of the driving controller and the output terminal of the compensation controller; and a second output terminal which is connected with a terminal of the light emitter, and the other terminal of the light emitter is connected with a third reference voltage line.

16. The organic electroluminescent display panel of claim 15, wherein in the light emitting phase, the light emitting controller is configured to, under the control of the light emitting control signal, supply the voltage of the first reference voltage line to the second input terminal of the driving controller, and store the data signal and the preset threshold voltage in the first input terminal of the driving controller.

17. The organic electroluminescent display panel of claim 15, wherein the driving controller comprises a first driving transistor and capacitor,
wherein the first driving transistor comprises a gate, which is the first input terminal of the driving controller; a source, which is the third input terminal of the driving controller; and a drain, which is the output terminal of the driving controller, and the first driving transistor has a threshold voltage equal to that of the driving controller; and
wherein the capacitor comprises a first terminal which is connected with the gate of the first driving transistor, and a second terminal which is the second input terminal of the driving controller.

18. The organic electroluminescent display panel of claim 15, wherein the initialization controller comprises a first switch transistor,
wherein the first switch transistor comprises a gate, which is the control terminal of the initialization controller; a source, which is the input terminal of the initialization controller; and a drain, which is the output terminal of the initialization controller.

19. The organic electroluminescent display panel of claim 18, wherein the compensation controller comprises a second switch transistor and a second driving transistor,
wherein the second switch transistor comprises a gate, which is the first control terminal of the compensation controller; a drain, which is the input teaninal of the compensation controller; and a source which is connected with the drain of the second driving transistor; and
wherein the second driving transistor comprises a gate, which is the second control terminal of the compensation controller; and a source, which is the output terminal of the compensation controller, wherein the second driving transistor has a threshold voltage equal to the preset threshold voltage.

20. The organic electroluminescent display panel of claim 19, wherein the second driving transistor has a size and shape identical to that of the first driving transistor.
